(19) United States
(12) Patent Application Publication
(10) Pub. No.: US 2022/0237216 A1
(43) Pub. Date: Jul. 28, 2022

(54) IMPRESSION EVALUATION APPARATUS, IMPRESSION EVALUATION METHOD AND PROGRAM

(71) Applicant: NIPPON TELEGRAPH AND TELEPHONE CORPORATION, Tokyo (JP)

(72) Inventor: Rika MOCHIZUKI, Tokyo (JP)

(73) Assignee: NIPPON TELEGRAPH AND TELEPHONE CORPORATION, Tokyo (JP)

(21) Appl. No.: 17/610,664

(22) PCT Filed: May 13, 2019
(86) PCT No.: PCT/JP2019/018970

§ 371 Date: Nov. 11, 2021

(51) Int. Cl. G06F 16/33; G06F 40/279; G06F 16/31; G06F 16/35

(52) U.S. Cl. CPC G06F 16/3334; G06F 16/35; G06F 16/31; G06F 40/279

(57) ABSTRACT

An impression evaluation device can quantitatively evaluate impressions of text strings, by including a first calculating unit that calculates values of a plurality of items regarding feature values of an input text string, and a second calculation unit that calculates, on the basis of a value calculated by the first calculating unit regarding one item out of the plurality of items selected on the basis of correlation between each of the plurality of items and an index evaluating an impression of a letter, and a storage unit storing a value of the index for each letter and values of the plurality of items, a value for the index with regard to the text string.

### TECHNICAL FIELD

The present invention relates to an impression evaluation device, an impression evaluation method, and a program.

### BACKGROUND ART

Technology for evaluating visual impression of text by experimentation and analyzing trends in evaluation by impression is being studied. There also is proposed technology for automatically estimating impression of new expressions regarding words that are not text.

For example, in NPL 1, in order to evaluate the visual impression of an overall text, handwritten text is presented to experiment participants, evaluation is performed on a seven-point scale by pairs of adjectives, and principal component analysis is performed to quantify the impression.

Also, in NPL 2, a system is proposed in which an evaluation experiment of impressions of onomatopoeia (imitative words, mimetic words) is performed, and the impression of a new onomatopoeia that is generated can be estimated on the basis of results thereof.

### CITATION LIST

### Non Patent Literature

[NPL 1] Yukie Tsuzuki, Noriko Shingaki, “Cognitive dimensions when perceiving others' handwriting”, 26th conference of Japanese Cognitive Science Society, p 2-19, 2009.
[NPL 2] Yuichiro Shimizu, Ryuichi Doizaki, Maki Sakamoto, “A System to Estimate an Impression Conveyed by Onomatopoeia”, Journal of The Japanese Society for Artificial Intelligence, Vol. 29, No. 1, SPI-E, pp. 41-52, 2014.

### SUMMARY OF THE INVENTION

### Technical Problem

In NPL 1, impression evaluation regarding one type of text prepared for experimentation is performed. Accordingly, tendencies of impressions regarding each pattern of text can be extracted by repeatedly performing similar experiments, but impressions regarding optional new text cannot be estimated. Accordingly, the method according to NPL 1 has a problem in that experimentation needs to be performed each time, and the method accordingly cannot be generalized.

In NPL 2, impressions of optional new onomatopoeic expressions are predicted on the basis of tendencies of impressions of onomatopoeia. However, features of onomatopoeia are subliminal notions evoked by phonology and words such as fluffy=soft, while visual impressions of assemblies of letters need elements regarding appearance such as the shape, weight, and so forth, of the letters, as feature values thereof, and accordingly this method cannot be applied as it is to prediction of visual impressions of text.

The present invention has been made in view of the foregoing points, and it is an object hereof to enable quantitative evaluation of impressions of text strings.

### Means for Solving the Problem

Accordingly, in order to solve the above problems, an impression evaluation device includes a first calculating unit that calculates values of a plurality of items regarding feature values of an input text string, and a second calculation unit that calculates, on the basis of a value calculated by the first calculating unit regarding one item out of the plurality of items selected on the basis of correlation between each of the plurality of items and an index evaluating an impression of a letter, and a storage unit storing a value of the index for each letter and values of the plurality of items, a value for the index with regard to the text string.

### Effects of the Invention

Impressions of text strings can be quantitatively evaluated.

### BRIEF DESCRIPTION OF DRAWINGS

FIG. 1 is a diagram illustrating a hardware configuration example of an impression evaluation device 10 according to an embodiment of the present invention.

FIG. 2 is a diagram illustrating a functional configuration example of the impression evaluation device 10 according to the embodiment of the present invention.

FIG. 3 is a flowchart for describing an example of processing procedures executed by the impression evaluation device 10.

FIG. 4 is a diagram illustrating a configuration example of a letter evaluation value DB 16.

FIG. 5 is a diagram illustrating a configuration example of a correlation value DB 15.

FIG. 6 is a diagram for describing an example of formulating an evaluation axis and distribution of a corresponding physical feature item.

FIG. 7 is a diagram illustrating a configuration example of a change value DB 17.

FIG. 8 is a diagram illustrating output examples of impression evaluation values.

### DESCRIPTION OF EMBODIMENTS

An embodiment of the present invention will be described below with reference to the Figures. In the present embodiment, a technology is disclosed in which impressions of optional text strings such as words, text, and so forth (hereinafter referred to as “letter assembly”) are estimated from impressions evaluation values of letters that are already evaluated, taking into consideration the degree of effects of ornamentation of the letters such as typeface, color, and so forth. Note that an impressions evaluation value is a values of an index relating to estimation of evaluation of impression of letters.

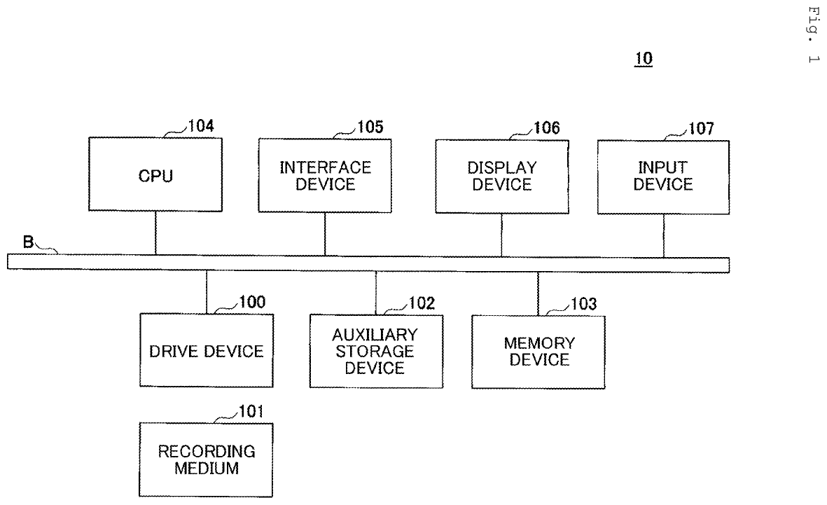

FIG. 1 is a diagram illustrating a hardware configuration example of an impression evaluation device 10 according to the embodiment of the present invention. The impression evaluation device 10 in FIG. 1 has a drive device 100, an auxiliary storage device 102, a memory device 103, a CPU 104, an interface device 105, a display device 106, and an input device 107 and so forth, which are connected to each other by a bus B.

A program that realizes the processing at the impression evaluation device 10 is provided by a recording medium 101 such as a CD-ROM. When the recording medium 101 storing the program is set in the drive device 100, the program is installed in the auxiliary storage device 102 from the recording medium 101 via the drive device 100. Note however, that installation of the program does not necessarily need to be performed by the recording medium 101, and may be downloaded from another computer via a network. The auxiliary storage device 102 stores the installed program, and also stores necessary files, data, and so forth.

In a case where there is a start instruction for the program, the memory device 103 reads out the program from the auxiliary storage device 102 and stores the program. The CPU 104 realizes the functions relating to the impression evaluation device 10 following the program stored in the memory device 103. The interface device 105 is used as an interface for connecting to a network. The display device 106 displays a GUI (Graphical User Interface) or the like, in accordance with the program. The input device 107 is configured of a keyboard and a mouse or the like, and is used for inputting various operation instructions.

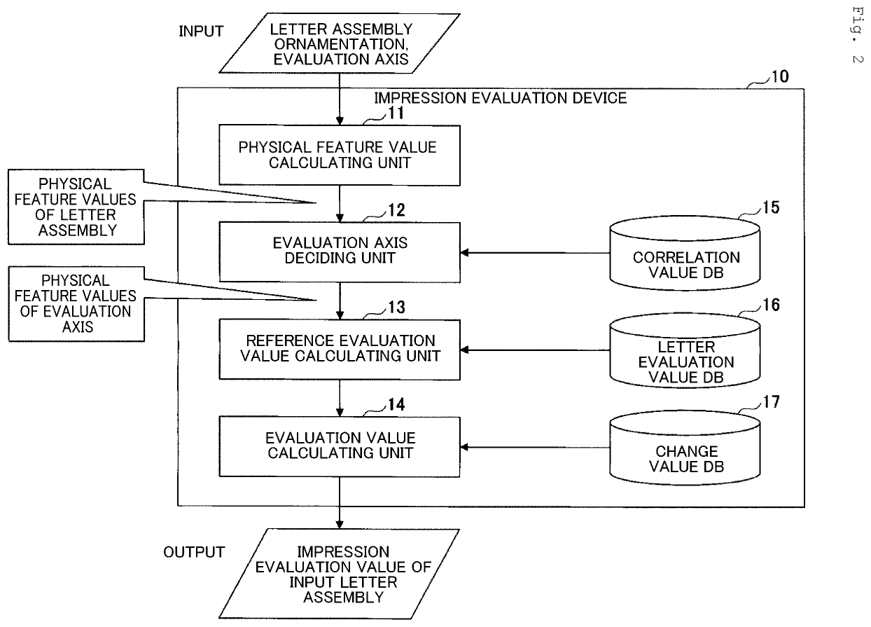

FIG. 2 is a diagram illustrating a functional configuration example of the impression evaluation device 10 according to the embodiment of the invention. In FIG. 2, the impression evaluation device 10 has a physical feature value calculating unit 11, an evaluation axis deciding unit 12, a reference evaluation value calculating unit 13, and an impression evaluation value calculating unit 14 and so forth. These units are realized by processing of one or more programs installed in the impression evaluation device 10 being executed by the CPU 104. The impression evaluation device 10 also uses databases (storage units) such as a correlation value DB 15, a letter evaluation value DB 16, and a change value DB 17 and so forth. These databases can be realized by using, for example, the auxiliary storage device 102, or a storage device that can be connected to the impression evaluation device 10 via a network, or the like.

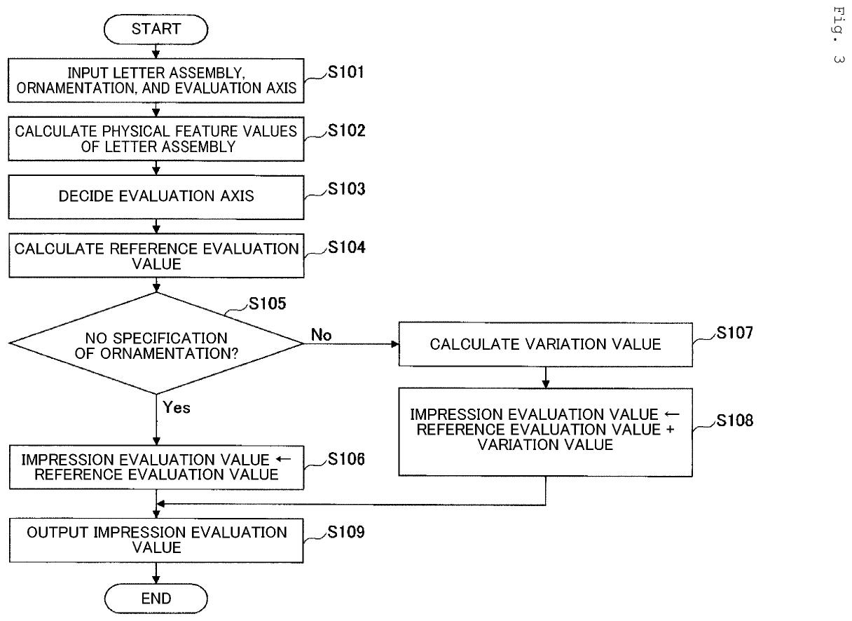

The processing procedures that the impression evaluation device 10 executes will be described below. FIG. 3 is a flowchart for describing an example of processing procedures that the impression evaluation device 10 executes.

In step S101, the physical feature value calculating unit 11 accepts input of a letter assembly (a text string of an optional number of letters that is one or more) that is the object of calculation of an impression evaluation value, ornamentation to be added to the letter assembly, and an a subjective evaluation value to be used as an evaluation axis for the impression evaluation value (hereinafter, referred to simply as “evaluation axis”). The letter assembly may be input as text via the input device 107 or the like, or content input by audio may be input by being converted into text, for example. It is sufficient for the input letter assembly to be an assembly of letters, and may be kanji, katakana, alphanumericals, Arabian, or the like.

Input of ornamentation is optional, and in a case where specifying the font, color, or the like of the letter assembly that is to be the object of evaluation is desired, the user may select from a font list, text color list, or the like, from a pulldown menu. Alternatively, the ornamentation may be selected at the same time as when inputting the text serving as the letter assembly.

The evaluation axis is information regarding what sort of perspective (i.e., on the basis of which subjective evaluation value as a reference) knowing the impression evaluation value of the letter assembly is desired. Input of the evaluation axis is optional, and the user may be presented with a list of subjective evaluation values contained in the letter evaluation value DB 16, such as softness, powerfulness, and so forth, to select from a pulldown menu, for example.

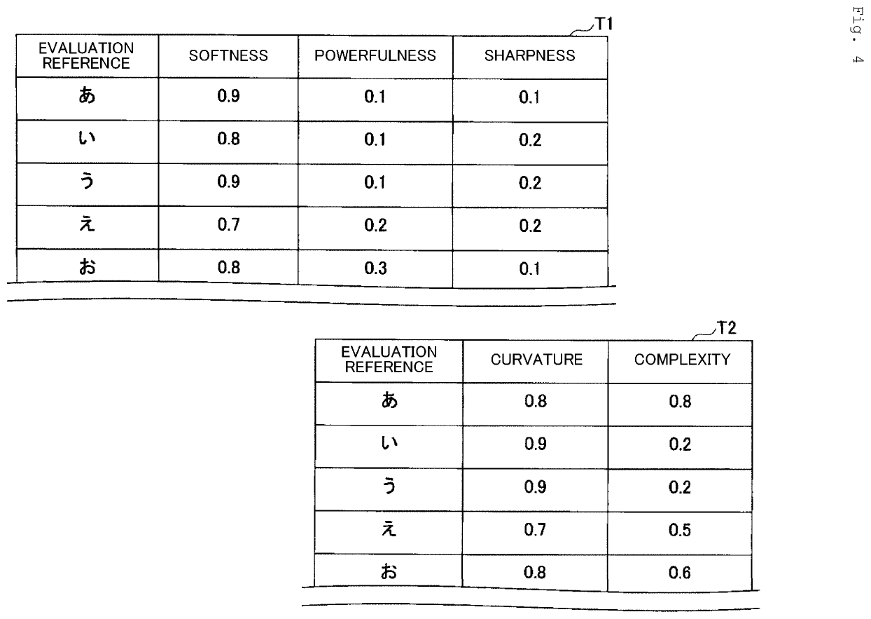

FIG. 4 is a diagram illustrating a configuration example of the letter evaluation value DB 16. As illustrated in FIG. 4, the letter evaluation value DB 16 stores, for each object of evaluation, such as the hiragana syllabary, a subjective evaluation value table T1 including items of a plurality of types of subjective evaluation values with regard to the objects of evaluation, a table T2 including values of items of a plurality of types of physical feature values with regard to the objects of evaluation, which are created and stored in advance. It is sufficient for the object of evaluation to be letters, and may include katakana, alphanumericals, and so forth.

Subjective evaluation values are average values or the like, obtained by indeterminate evaluators subjectively evaluating each of an optional number of items that is one or more regarding impressions of the visual appearance of letters, on a five-point scale, or the like, and averaging values relating to evaluation of impressions of the letters. For example, items making up subjective evaluation values include one or more of softness, powerfulness, and sharpness. Note however, that these items are not fundus, as long as items by which the degree of impression of the letters can be evaluated.

Physical feature values are objective observation values regarding an optional number of items that is one or more regarding the visual appearance of the object of evaluation. Items making up the physical feature values include, for example, one or more of curvature, which represents the degree of curving of letters, the complexity of the shapes, and so forth. Note however, that this is not limited to particular items, as long as items that can be observed and quantified in one way or another. For example, with regard to curvature, the degree of curving of each letter can be calculated by a method described in “Takanori Komatsu, Satoshi Nakamura, Masaaki Suzuki, ‘Don't you think Hiragana is rounder than Katakana?’: Availabilities of Mathematical Representations of Characters and its Curvature, Information Processing Society of Japan Technical Report, Vol. 2014-HCI-159, No. 7, 2014”, or the like. Also, complexity of letters can be calculated using software that can calculate the percentage of black within an image (e.g., “GIMP” https://www.gimp.org/) or the like.

Note that the values of each of the items of the subjective evaluation values and physical feature values are normalized to values within a range of 0 to 1, and stored in the letter evaluation value DB 16.

Next, the physical feature value calculating unit 11 calculates the physical feature values of the letter assembly that has been input (hereinafter referred to as “input letter assembly”) (S102). A method that is the same as known technology that may be used for calculating curvature, complexity, and so forth, at the time of creating the letter evaluation value DB 16, may be used for calculating these physical features. Note however, that in step S102, each of the physical feature values such as curvature, complexity, and so forth, is calculated for the input letter assembly, and not one letter at a time.

Next, the evaluation axis deciding unit 12 references the correlation value DB 15 and decides the evaluation axis for calculating the impression evaluation value for the input letter assembly (S103). This evaluation axis is selected from the items of the plurality of subjective evaluation values making up the columns in the table T1 of the letter evaluation value DB 16.

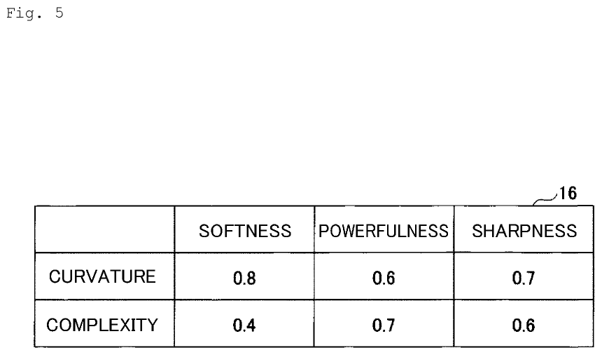

FIG. 5 is a diagram illustrating the configuration example of the correlation value DB 15. As illustrated in FIG. 5, for each combination of each item in the subjective evaluation values and each item in the physical feature values, a value representing the height of correlation between the items regarding the combination (hereinafter referred to as “correlation value”) is stored in the correlation value DB 15 in advance. Note that in FIG. 5, the items of subjective evaluation values are laid out in the column direction, and the items of physical feature values are laid out in the row direction. The correlation value for each combination may be calculated using a value group (number sequence) of the letters regarding the item for the subjective evaluation value regarding this combination, and a value group (number sequence) of the letters regarding the item for the physical feature values regarding this combination, in the letter evaluation value DB 16. For example, the Excel CORREL function or the like may be used to calculate a correlation function as the correlation value. Note however, that the calculation method is optional, and another method may be used as long as a method for calculating the height of correlation among number sequences.

In step S103, in a case where an item for a subjective evaluation value to serve as an evaluation axis is specified by the user as input, the evaluation axis deciding unit 12 first selects the item of the physical feature values of which the correlation with this evaluation axis is the highest (hereinafter referred to as “corresponding physical features item”). For example, in a case where “softness” is specified as the evaluation axis, the “curvature” of which the correlation with “softness” is highest in the example in FIG. 5 is selected as the corresponding physical features item. Conversely, in a case where no evaluation axis is specified, the evaluation axis deciding unit 12 selects, with regard to the combination in which the correlation value is highest between the item in the subjective evaluation values and the item in the physical feature values, the item in the subjective evaluation values as the evaluation axis, and selects this item from the physical feature values as the corresponding physical features item. In the example in FIG. 5, selection is made of evaluation axis=softness and corresponding physical features item=curvature, of which the correlation value is the highest at 0.8. The evaluation axis deciding unit 12 outputs the decided evaluation axis and the corresponding physical features item to the evaluation axis deciding unit 12.

Next, the reference evaluation value calculating unit 13 takes the evaluation axis and the corresponding physical features item output from the evaluation axis deciding unit 12 as input, and references the letter evaluation value DB 16 to calculate an impression evaluation value for the input letter assembly for a case of not taking ornamentation into consideration (hereinafter referred to as “reference evaluation value”) (S104). Specifically, the reference evaluation value calculating unit 13 references values stored in the letter evaluation value DB 16 with regard to the evaluation axis and the corresponding physical features item that are input, and formulates the distribution of the evaluation axis and the corresponding physical features item.

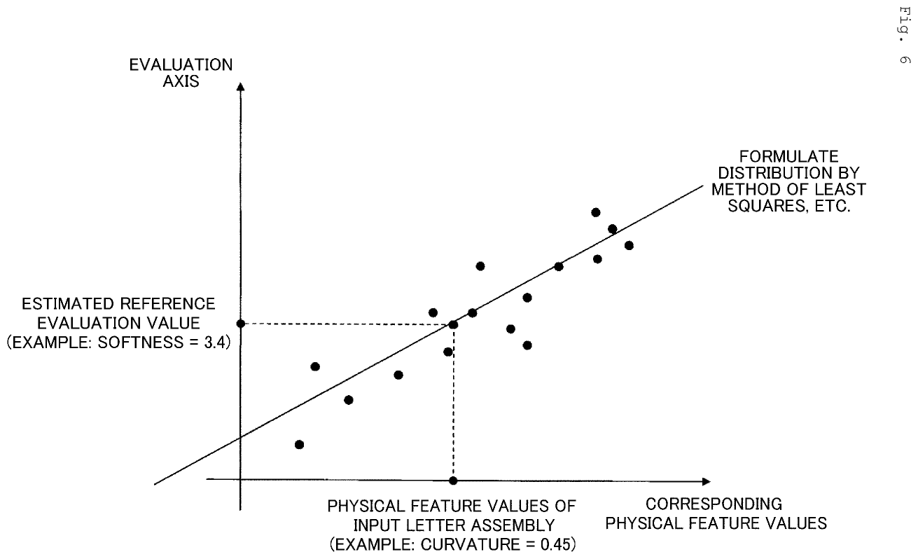

FIG. 6 is a diagram for describing an example of formulating the evaluation axis and distribution of the corresponding physical features item. In the graph in FIG. 6, the vertical axis is an item of a subjective evaluation value serving as the evaluation axis (e.g., “softness”), and the horizontal axis is the corresponding physical features item (e.g., “curvature”). Each plot in this graph is based on each value of the evaluation axis and the corresponding feature value feature item of each evaluation reference (each letter) in the letter evaluation value DB 16. That is to say, one plot corresponds to one evaluation reference (letter).

As illustrated in FIG. 6, the reference evaluation value calculating unit 13 may estimate a straight line from the coordinates distribution of plotted points by a method such as the method of least squares, for example, obtain a value for the evaluation axis for the input letter assembly that has been input, on the basis of the value of the corresponding physical features item calculated in step S102 and this straight line, and take this value of the evaluation axis as the reference evaluation value of the input letter assembly. Note that estimation of formulation (straight line) may be performed in advance. That is to say, formulation may be performed for each set of subjective evaluation value item and physical feature value item, and a parameter indicating the straight line obtained by formulation may be stored in the auxiliary storage device 102 in advance. In this case, it is sufficient for the reference evaluation value calculating unit 13 to read out the parameter corresponding to the evaluation axis and the corresponding physical features item, and calculate the reference evaluation value for the input letter assembly on the basis of the straight line defined by this parameter.

Next, the impression evaluation value calculating unit 14 determines whether or not the ornamentation is specified by the user (S105). In a case where ornamentation is not specified (Yes in S105), the impression evaluation value calculating unit 14 substitutes the reference evaluation value calculated in step S104 into the subjective evaluation value of the input letter assembly (S106).

Conversely, in a case where ornamentation is specified by the user (No in S105), the impression evaluation value calculating unit 14 references the change value DB 17, and executes processing for reflecting the change amount of impression (hereinafter referred to as “variation value”) due to this ornamentation (hereinafter referred to as “specified ornamentation”) in the reference evaluation value of the input letter assembly (i.e., changing the reference evaluation value on the basis of the specified ornamentation).

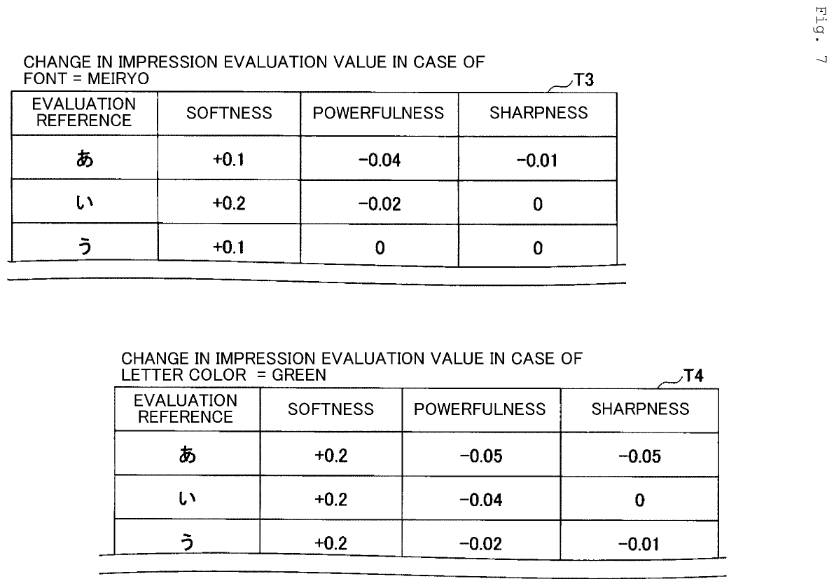

FIG. 7 is a diagram illustrating a configuration example of the change value DB 17. As illustrated in FIG. 7, the change value DB 17 stores the difference in impression evaluation values between a case of adding ornamentation to each evaluation reference (each letter) and a case of not doing so (hereinafter referred to as “change value”), in each table by type of ornamentation. Ornamentation represents the difference as to the evaluation object used when creating the letter evaluation value DB 16, such as change in the font of the letter, change in letter color, and so forth. In FIG. 7, a table T3 is a table in which is registered the change value for each evaluation reference (each letter) regarding ornamentation of “font=Meiryo”. A table T4 is a table in which is registered the change value for each evaluation reference (each letter) regarding ornamentation of “letter color=green”.

First, the impression evaluation value calculating unit 14 references the column of the evaluation axis in the table corresponding to the specified ornamentation in the change value DB 17, and calculates the change value (S107). For example, in a case where the specified ornamentation is “font=Meiryo”, and the evaluation axis is “softness”, the impression evaluation value calculating unit 14 calculates the correlation between the number sequence of the column “softness” in the table T3 in FIG. 7 and the number sequence of the column of the corresponding physical features item in table T2 in the letter evaluation value DB 16, using the Excel CORREL function or the like. In a case where there is a correlation between the specified ornamentation and the corresponding physical features item (a condition is set such as absolute value of correlation coefficient≥0.5, for example), the impression evaluation value calculating unit 14 formulates the distribution regarding the specified ornamentation and the corresponding physical features item in the same way as in step S104, identifies the change value corresponding to the physical feature values of the input letter assembly, and takes this change value as the variation value. Note that formulation may be performed in advance, in the same way as in step S104. Alternatively, the impression evaluation value calculating unit 14 may calculate the average value of a change value group of a column corresponding to the specified ornamentation as the change value.

In a case where there is a plurality of specified ornamentations, (e.g., a case where the font is Meiryo and the letter color is green, or the like), the impression evaluation value calculating unit 14 calculates the variation value by a method of calculating the variation value for each specified ornamentation using one of the methods above, and using the variation value with the larger absolute value, taking the average value or the added value, or the like.

Following this, the impression evaluation value calculating unit 14 substitutes the results of adding the variation value to the reference evaluation value into the impression evaluation value (S108). Following step S106 or S108, the impression evaluation value calculating unit 14 outputs the impression evaluation value (S109). For example, a numerical value as the impression evaluation value, and the evaluation axis at the time of the impression evaluation, may be output.

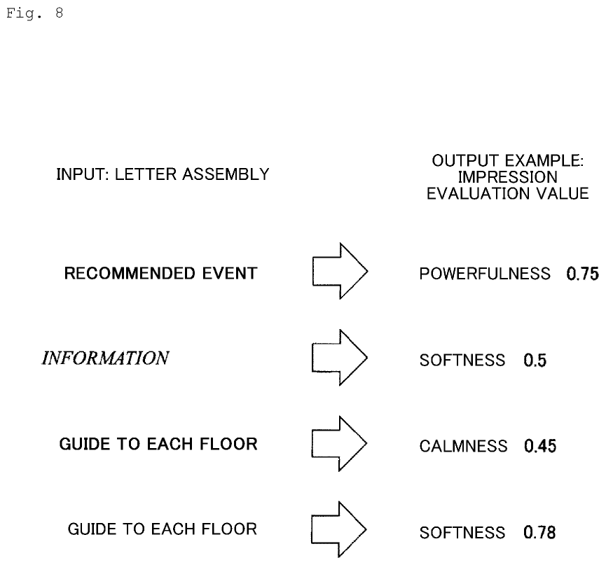

FIG. 8 is a diagram illustrating output examples of impression evaluation values. FIG. 8 shows an output example of the impression evaluation value for each letter assembly that is input. FIG. 8 shows an example in which the impression evaluation values are output in an “evaluation axis: impression evaluation value” format. Note however, that the output format of the impression evaluation value is not limited to a predetermined format.

As described above, according to the present embodiment, impressions of optional letter assemblies (text strings) can be quantitatively evaluated. As a result, when presenting information in which the impression of the visual appearance is important, such as signages and so forth, the burden of conceiving designs of letters in text and so forth by one's self or the trouble of commissioning this to a designer can be reduced, and also the trouble of performing impression evaluation experimentation at the time of coming up with product names and so forth can be reduced.

Note that in the present embodiment, the physical feature value calculating unit 11 is an example of a first calculating unit. The reference evaluation value calculating unit 13 is an example of a second calculating unit. The evaluation axis deciding unit 12 is an example of a selecting unit. The impression evaluation value calculating unit 14 is an example of a changing unit. The feature values are an example of the physical feature values.

Although an embodiment of the present invention has been described above in detail, the present invention is not limited to this particular embodiment, and various types of modifications and alterations may be made within the scope of the essence of the present invention set forth in Claims.

### REFERENCE SIGNS LIST

10 Impression evaluation device
11 Physical feature value calculating unit
12 Evaluation axis deciding unit
13 Reference evaluation value calculating unit
14 Impression evaluation value calculating unit
15 Correlation value DB
16 Letter evaluation value DB
17 Change value DB
100 Drive device
101 Recording medium
102 Auxiliary storage device
103 Memory device
104 CPU
105 Interface device
106 Display device
107 Input device
B Bus

1. An impression evaluation device, comprising:
a first determiner configured to determine values of a plurality of items regarding feature values of an input text string; and
a second determiner configured to determine, on the basis of a value determined by the first determiner regarding one item out of the plurality of items selected on the basis of correlation between each of the plurality of items and an index evaluating an impression of a letter, and a store configured to storing a value of the index for each letter and values of the plurality of items, a value for the index with regard to the text string.

2. The impression evaluation device according to claim 1, further comprising:
a selector, on the basis of correlation between each of the plurality of items and each of a plurality of the indices, and a value determined by the first determiner, configured to select one of the indices and an item of one of the feature values, wherein the second determiner determines, on the basis of a value that the store stores with regard to the index and the item of the feature values selected by the selector, and a value of the item of the feature values selected by the selector, a value of the index selected by the selector regarding the text string.

3. The impression evaluation device according to claim 1, wherein the feature values include one or more of curvature and complexity of letters configuring the text string.

4. The impression evaluation device according to claim 1, wherein the indices include one or more of softness, powerfulness, and sharpness.

5. The impression evaluation device according to claim 1, further comprising:
a changer configured to change a value determined by the second determiner, on the basis of ornamentation added to the text string.

6. A computer-implemented method for evaluating impression, the method comprising:
determining, by a first determiner, values of a plurality of items regarding feature values of an input text string; and
determining, by a second determiner based on a value determined by the first determiner regarding one item out of the plurality of items selected on the basis of correlation between each of the plurality of items and an index evaluating an impression of a letter, and a store configured to store a value of the index for each letter and values of the plurality of items, a value for the index with regard to the text string.

7. A computer-readable non-transitory recording medium storing computer-executable program instructions that when executed by a processor cause a computer system to:
determine, by a first determiner, values of a plurality of items regarding feature values of an input text string; and
determine, by a second determiner based on a value determined by the first determiner regarding one item out of the plurality of items selected on the basis of correlation between each of the plurality of items and an index evaluating an impression of a letter, and a store configured to store a value of the index for each letter and values of the plurality of items, a value for the index with regard to the text string.

8. The impression evaluation device according to claim 2, wherein the feature values include one or more of curvature and complexity of letters configuring the text string.

9. The impression evaluation device according to claim 2, wherein the indices include one or more of softness, powerfulness, and sharpness.

10. The impression evaluation device according to claim 2, further comprising:
a changer configured to change a value determined by the second determiner, on the basis of ornamentation added to the text string.

11. The computer-implemented method according to claim 6, further comprising:
selecting, by a selector, on the basis of correlation between each of the plurality of items and each of a plurality of the indices, and a value determined by the first determiner, configured to select one of the indices and an item of one of the feature values, wherein the second determiner determines, on the basis of a value that the store stores with regard to the index and the item of the feature values selected by the selector, and a value of the item of the feature values selected by the selector, a value of the index selected by the selector regarding the text string.

12. The computer-implemented method according to claim 6, wherein the feature values include one or more of curvature and complexity of letters configuring the text string.

13. The computer-implemented method according to claim 6, wherein the indices include one or more of softness, powerfulness, and sharpness.

14. The computer-implemented method according to claim 6, further comprising:
changing, by a changer, a value determined by the second determiner, on the basis of ornamentation added to the text string.

15. The computer-implemented method according to claim 11, wherein the feature values include one or more of curvature and complexity of letters configuring the text string.

16. The computer-implemented method according to claim 11, wherein the indices include one or more of softness, powerfulness, and sharpness.

17. The computer-implemented method according to claim 11, further comprising:
changing, by a changer, a value determined by the second determiner, on the basis of ornamentation added to the text string.

18. The computer-readable non-transitory recording medium according to claim 7, the computer-executable program instructions when executed further causing the computer system to
selecting, by a selector, on the basis of correlation between each of the plurality of items and each of a plurality of the indices, and a value determined by the first determiner, configured to select one of the indices and an item of one of the feature values, wherein the second determiner determines, on the basis of a value that the store stores with regard to the index and the item of the feature values selected by the selector, and a value of the item of the feature values selected by the selector, a value of the index selected by the selector regarding the text string.

19. The computer-readable non-transitory recording medium according to claim 7, wherein the feature values include one or more of curvature and complexity of letters configuring the text string.

20. The computer-readable non-transitory recording medium according to claim 7, wherein the indices include one or more of softness, powerfulness, and sharpness.
